(19) United States
(12) Patent Application Publication
(10) Pub. No.: US 2002/0088059 A1
(43) Pub. Date: Jul. 11, 2002

(54) Bag with detachable cushion

(76) Inventor: Brian Reeves, San Clemente, CA (US)

Correspondence Address: Mr. Gene Scott, Patent Law & Venture Group, 3151 Airway Ave., Suite K-105, Costa Mesa,, CA, 92626, US

(21) Appl. No.: 09/755,387

(22) Filed: Jan. 5, 2001

(51) Int. Cl. B65D 30/00; B68G 5/00

(52) U.S. Cl. 5/653; 383/4; 190/1

(57) ABSTRACT

A bag provides an exterior fabric wall enclosing an interior space for carrying goods. The exterior wall provides an aperture for receiving the goods to the bag's interior and also a first attachment element. A cushion comprises a second attachment element, with the first and second attachment elements removably joining the cushion to the exterior wall of the bag so that the bag and the cushion may be jointly carried and the cushion may be fully removed from the bag for use alone.

### BACKGROUND OF THE INVENTION

1. Field of the Invention

This invention relates generally to bags for carrying goods and more particularly to such a bag that provides a detachable cushion.

2. Description of Related Art

The following art defines the present state of this field:

Paletta et al., U.S. D293868 describes a combined cushion and carrying bag.

Moore, Jr., U.S. D366,800 describes a combined stadium cushion and carrying bag.

Rosenberg, U.S. Pat. No. 2,047,035 describes a valise having its side members disposed angularly to each other, one of said side members forming a hinged cover, means for securing said cover at various angles to the valise, a blanket secured to the valise and adapted to be extended from the bottom thereof to form a seat when the valise is placed on the ground, the cover adapted to form a back-rest, and means for securing the free end of said blanket to the valise.

Ritchey, U.S. Pat. No. 2,618,790 describes a traveler's accessory in the nature of a combined seat, pillow and article-receiving bag, comprising in combination a pillow, a removable slip therefor open at one end into which the pillow is inserted, tabs extending from opposite ends of said pillow, a fastener element adjacent the free end of each tab, said pillow slip having a slot at its closed end through which one of said pillow-carried tabs is projected, the other tab extended through the open end of said slip, a receptacle removably receiving said pillow and slip and made of flexible wear-resistant waterproof material, said receptacle having side and end walls providing a substantially continuous pillow embracing flange, fastener elements carried by the inner surfaces of the end walls of said receptacle and cooperating with the tab-carried fasteners to secure the pillow and receptacle together, the side walls of said receptacle tapering to reduced height from each end toward the mid-portion of said receptacle whereby to divide said receptacle into matching sections of triangular form as viewed in side elevation and to provide a transverse fold-facilitating area intermediate the ends of said receptacle, cooperating fastening means carried by the side and end walls of said receptacle sections and engageable with one another when the sections are folded inwardly and carrying means carried by the ends of each receptacle section.

Warner, U.S. Pat. No. 2,865,433 describes a stadium cushion unit having a pair of flat resilient cushions, means to secure said cushions in flat side-by-side folded relationship and in extended coplanar relationship, a collapsible bag open along one of its ends and secured to the forward edge of one of said cushions, a cover overlying and hinged to the open end of said bag, and securing means secured to one of said cushions and adapted to hold said cushions and adapted to hold said cushions folded together against one side of said bag, and cooperating securing means on said cover separably engageable with the securing means on said cushions folded compactly against said bag.

Grahl, U.S. Pat. No. 4,535,878 describes a plug-fastener for safety belts in motor vehicles, which comprises a tongue-like plug part and a receiving part for receiving and retaining the tongue-like plug part. The plug part is provided with at least one recess, undercut, or a shoulder. The receiving part comprises at least one locking member which engages the recess, undercut or shoulder of the plug part, and, after the plug part has been received by the receiving part, is operable to retain these parts until the parts are separated deliberately. In the receiving part in the path of movement of the plug part there is movably arranged a holding member one end or extension of which is adapted to engage the locking member in its unlocked position and to prevent the latter from moving into its locking position until the plug part has contacted the holding member and has moved it out of engagement with the locking member.

Kiechlin, U.S. Pat. No. 4,783,120 describes an independent seat cushion used primarily to provide seating comfort at commercial locations, such as stadiums, conventions, arenas or the like, which is readily carried to the use site, which employs a detachable pouch or pocket for carrying incidental items and, in one form, includes a pivotal back rest. Typically, slide fasteners are employed for pouch or pocket detachment, as well as for the placement of resilient material defining the body of the cushion. The cushion itself can assume various configurations in plan view, and an adjustable strap is provided for ready carrying.

Carter, U.S. Pat. No. 4,863,003 describes a combination seat cushion and tote bag comprising a seating portion and at least one side portion having a pocket enclosure secured to its upper surface and including means for releasably securing the side portion in an overlapped relationship with the seating portion and further including a handle means.

Carey, U.S. Pat. No. 4,945,589 describes a combination seat cushion and carrying bag having two opposed padded compartments and a pocket for storing articles in between. The articles are cushioned by the padded compartment when the article is used as a seat cushion.

Strevey, WO 00/03926 describes a foldable bag comprising a laminate panel section and a plurality of pockets. The bag is foldable to assume a folded closed configuration, an unfolded flat configuration, or a folded open configuration. The bag is adapted to be supported by a support structure, such as a chair back, wherein the plurality of pockets are in an upright orientation and readily accessible.

The prior art teaches the use of bags for carrying goods and also, bags with portions for use as a cushion, but the prior art does not teach a bag wherein the cushion may be fully separated from the bag for use separately. The present invention fulfills these needs and provides further related advantages as described in the following summary.

### SUMMARY OF THE INVENTION

The present invention teaches certain benefits in construction and use which give rise to the objectives described below. A bag provides an exterior fabric wall enclosing an interior space for carrying goods. The exterior wall provides an aperture for receiving the goods to the bag's interior and also a first attachment element. A cushion comprises a second attachment element, with the first and second attachment elements removably joining the cushion to the exterior wall of the bag so that the bag and the cushion may be jointly carried and the cushion may be fully removed from the bag for use alone.

A primary objective of the present invention is to provide an apparatus and method of use of such apparatus that provides advantages not taught by the prior art.

Another objective is to provide such an invention capable of carrying goods as well as a cushion.

A further objective is to provide such an invention capable of removing the cushion from the bag such that each may be used for its own characteristics separately.

A still further objective is to provide such an invention capable of using the cushion as a bottom portion for standing the bag upon.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a perspective view of the preferred embodiment of the invention;

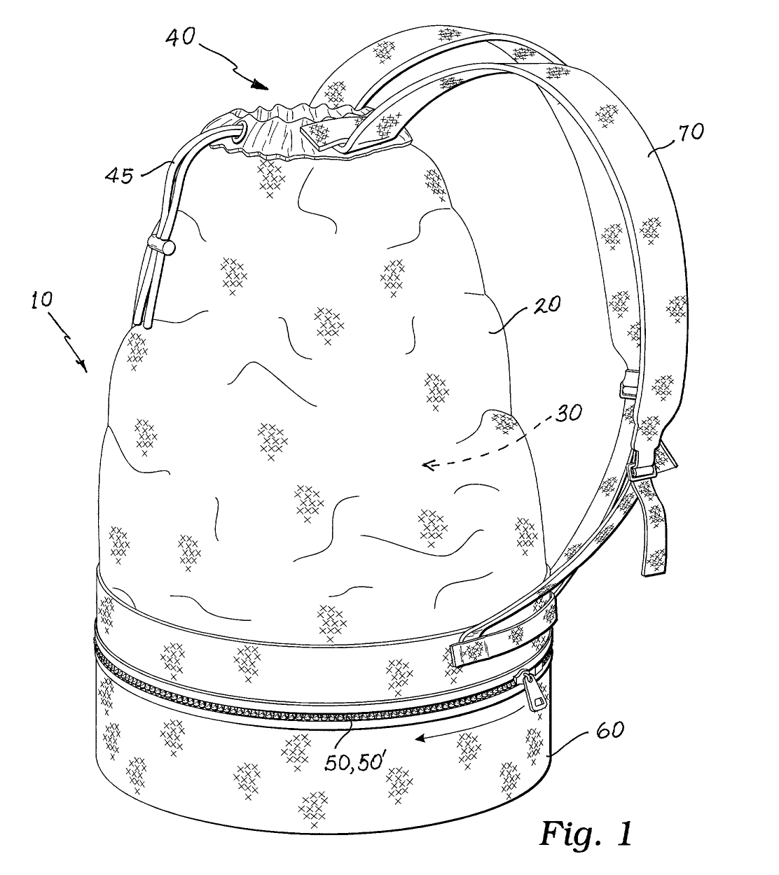

FIG. 2 is similar to that of FIG. 1 further showing a bag of the invention separated from a cushion of the invention; and

FIG. 3 is similar to that of FIG. 2 further showing that the bag and the cushion may be advantageously used separately.

### DETAILED DESCRIPTION OF THE INVENTION

The above described drawing figures illustrate the invention in at least one of its preferred embodiments, which is further defined in detail in the following description.

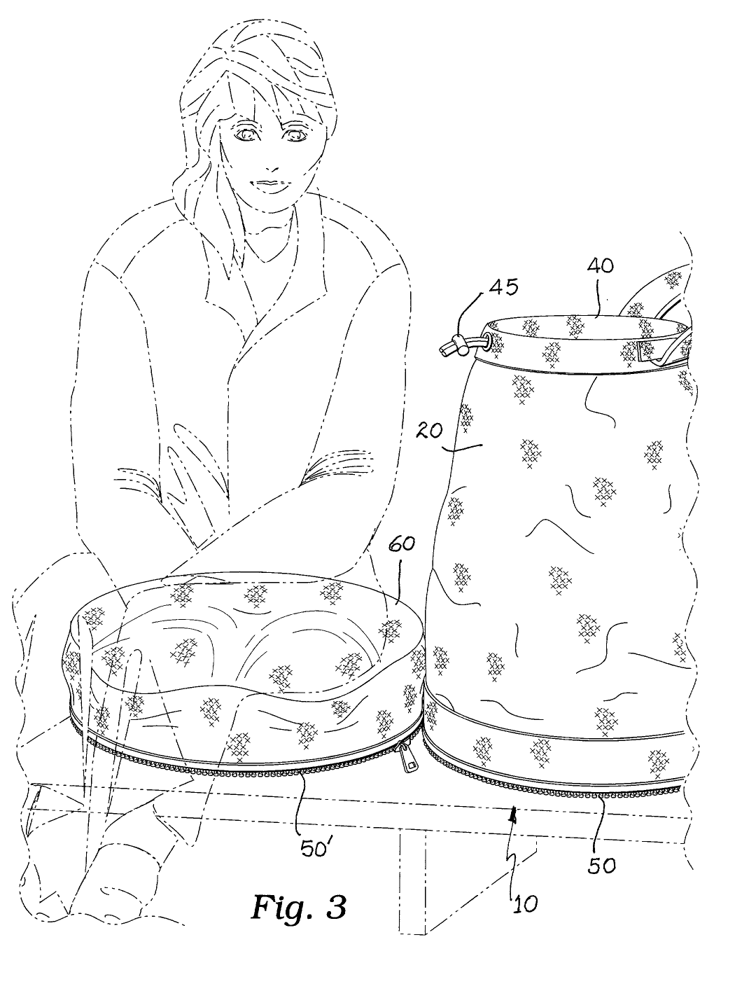

The present invention is an apparatus comprising a bag 10 providing an exterior wall 20 made of a sheet of cloth, plastic, metal or any other material and enclosing an interior space 30 for carrying goods such as food stuffs, beach wear, sporting goods, and so on (not shown). The exterior wall 20 further provides an aperture 40 for receiving the goods, and still further comprising a first attachment element 50. The invention further provides a cushion 60 comprising a second attachment element 50′, the first and second attachment elements 50, 50′ removably joining the cushion 60 to the exterior wall 20 of the bag 10 so that the bag 10 and the cushion 60 may be jointly carried and also, the cushion 60 may be fully removed from the bag 10 for use separately as shown in FIG. 3. Preferably, the first and the second attachment elements 50, 50′ are portions of a zipper closure, although other attachment means may be used, as for instance, Velcro®, snaps, clips and so on.

Preferably, the cushion 60 forms a bottom of the bag 10, with the aperture 40 positioned in opposition to the cushion 60 at a top of the bag 10 as shown in the figures. The aperture is preferably engaged with a draw string closure 45 as shown, but may also be sealed with a zipper or other closure types including Velcro®. The bag 10 further preferably comprises a carrying means 70, such as a strap, engaged with the exterior wall 20 of the bag 10 and extending outwardly therefrom, preferably from a point adjacent to the aperture 40 to a point adjacent to the first attachment element 50 near the cushion 50′.

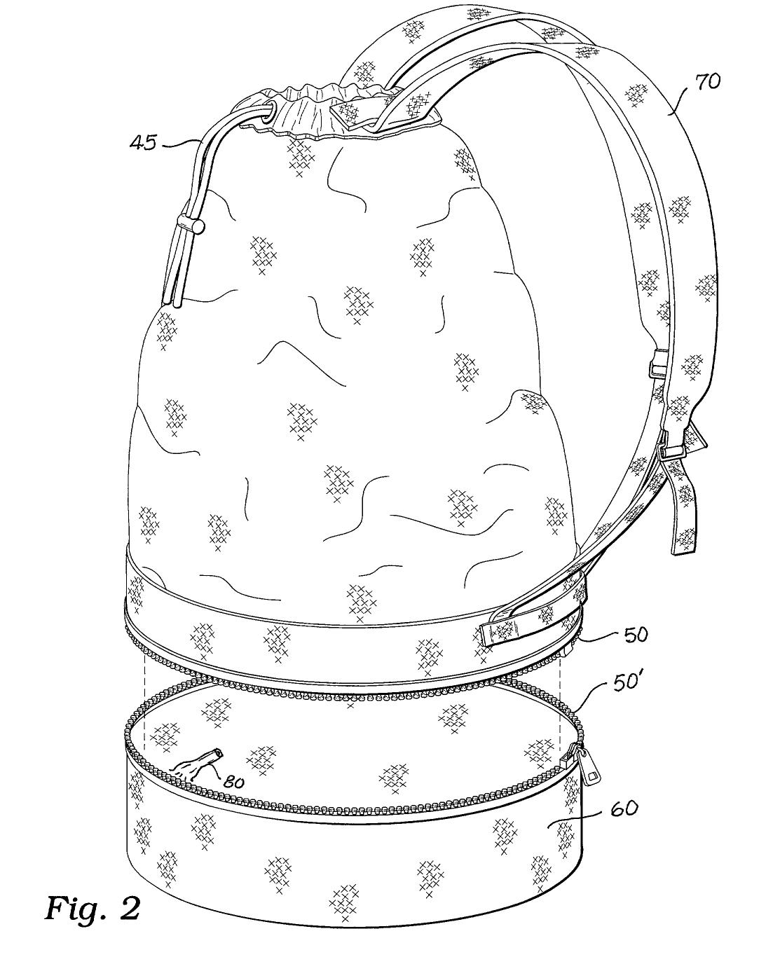

The cushion 60 preferably is made of a foam rubber interior covered by a fabric cover and having size and shape necessary for sitting upon at a beach or stadium. In this embodiment, the cushion is a self supporting resilient structure. Alternately, the cushion may be an inflatable device providing collapsible exterior walls which may be manually or mechanically inflated via an inflation tube well known in the art. Such a tube may have an air valve 80 such as is in common use for inflating inner-tubes and tires. See FIG. 2.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. An apparatus comprising:
a bag providing an exterior wall enclosing an interior space for carrying goods, the exterior wall providing an aperture for receiving the goods, the exterior wall further comprising a first attachment element;
a cushion comprising a second attachment element, the first and second attachment elements removably joining the cushion to the exterior wall of the bag so that the bag and the cushion may be jointly carried and the cushion may be fully removed from the bag for use thereof.

2. The apparatus of claim 1 wherein the first and the second attachment elements are portions of a zipper closure.

3. The apparatus of claim 1 wherein the cushion forms a bottom of the bag, the aperture positioned in opposition to the cushion at a top of the bag.

4. The apparatus of claim 1 wherein the aperture is engaged with a draw string closure.

5. The apparatus of claim 1 further comprising a carrying means engaged with the exterior wall of the bag and extending outwardly therefrom.

6. The apparatus of claim 5 wherein the carrying means comprises at least one strap engaged with the exterior wall of the bag adjacent to the aperture and further adjacent to the first attachment element.

7. The apparatus of claim 1 wherein the cushion is an inflatable device.

8. The apparatus of claim 1 wherein the cushion is a self supporting resilient structure.
